(19) United States
(12) Patent Application Publication
(10) Pub. No.: US 2014/0250612 A1
(43) Pub. Date: Sep. 11, 2014

(54) Data Transferring Powered Toothbrush

(71) Applicant: Beam Technologies, LLC, Louisville, KY (US)

(72) Inventors: Alexander D. Curry, Louisville, KY (US); Alex X. Frommeyer, Louisville, KY (US); Daniel E. Dykes, Louisville, KY (US)

(73) Assignee: Beam Technologies, LLC, Louisville, KY (US)

(21) Appl. No.: 14/198,100

(22) Filed: Mar. 5, 2014

Related U.S. Application Data
(60) Provisional application No. 61/773,098, filed on Mar. 5, 2013.

(51) Int. Cl. A61C 17/22; A46B 15/00

(52) U.S. Cl. CPC A61C 17/221; A46B 15/0002
USPC 15/22.1

(57) ABSTRACT

A data transferring powered toothbrush is provided for use during oral health care activities carried out daily by a user. A powered toothbrush is provided including an orientation sensor that provides data relating toothbrush usage to various positions within the oral cavity. Further, the toothbrush comprises a data extractor that provides a means for transferring the data from the toothbrush to an external medium for viewing and manipulation. Further still, the powered toothbrush is comprised in a system including a data transfer medium (i.e. “smartphone”) and the Cloud, which allows for data transfer between multiple external mediums from the powered toothbrush. The system further allows for passive participation in social games with awards and incentives. The system and powered toothbrush further provide for active participation in brushing games to encourage proper brushing techniques.

### CROSS-REFERENCE TO RELATED APPLICATIONS

This application claims priority to U.S. Provisional Application No. 61/773,098 filed on Mar. 5, 2013.

### BACKGROUND OF THE INVENTION

This invention relates to oral health care implements and systems, particularly relating to improved toothbrushes utilizing new technologies for the dental field. In particular, the invention relates to the data transferring powered toothbrush.

Dental plaque is a biofilm that forms naturally on teeth between brushing and dental visits. Dental plaque can be a precursor to more severe oral health problems including: dental caries, tooth decay, gingivitis, and chronic periodontitis. The occurrence of dental caries is one of the largest health epidemics in the world and is the most common chronic childhood disease in the United States. Likewise, gingivitis and dental calculus are two of the most common systemic diseases of the body. It is desirable to more effectively remove dental plaque early stage as a preventive measure against more serious disease states. The most common preventive measure implemented to control the formation of dental plaque is the toothbrush.

Further still, clinical dental visits with dental practitioners are a method of prevention and detection of dental plaque. Regular dental visits are recommended to occur every six months. Regular toothbrush replacement is recommended to occur every three months according to dental practitioners. The lack of adherence to these recommendations and lack of brushing compliance is often a contributing factor to the development of dental plaque and its associated complications. Regular replacement of toothbrushes is often disregarded by users and cause issues as bristles become deformed and are no longer providing the proper cleaning.

Additionally, the introduction of data logging in toothbrushes presents unique challenges to the existing toothbrush market. It is common for more expensive powered toothbrush bases to be used by multiple users that interchange heads depending on the user. This provides the challenge of identifying the user that is currently using the toothbrush base and logging data.

Consequently, consumers and medical professionals are in need of a toothbrush with data transferring capabilities. Moreover, consumers and medical professionals are in need daily monitoring to facilitate predicative health models. Further, consumers are in need of incentives for completing daily routines to encourage proper preventative health. Consequently, a method for handle vibration in powered toothbrushes is desirable.

### BRIEF SUMMARY OF THE INVENTION

The invention aims to provide an improved data transferring powered toothbrush. The toothbrush has bristles for cleaning and is often provided in a system further comprising a data transfer medium and the Cloud, which allows for data transfer between multiple platforms from the toothbrush.

The powered toothbrush includes an orientation sensor that measures the orientation of the toothbrush. The powered toothbrush further comprises a motor housing that contains an electromechanical drive to provide mechanical movement to the brush head.

Additionally, the powered toothbrush comprises a buffer between the motor housing and the handle. Often, the buffer is made from a material more pliable than both the handle and the motor housing. The buffer reduces the amount of vibration transferred to the handle while amplifying the vibration transferred to the brush head.

Accordingly, several advantages are to provide a powered toothbrush, to provide an orientation sensor to measure the orientation of the brush head, to provide transmission of data from the toothbrush to either a data transfer medium or the Cloud, and to provide a buffer between the handle and the motor housing. Still further advantages will become apparent from a study of the following descriptions and accompanying drawings.

### BRIEF DESCRIPTION OF THE DRAWINGS

FIG. 1 is a perspective view of a toothbrush with bristles and a buffer according to multiple embodiments and alternatives.

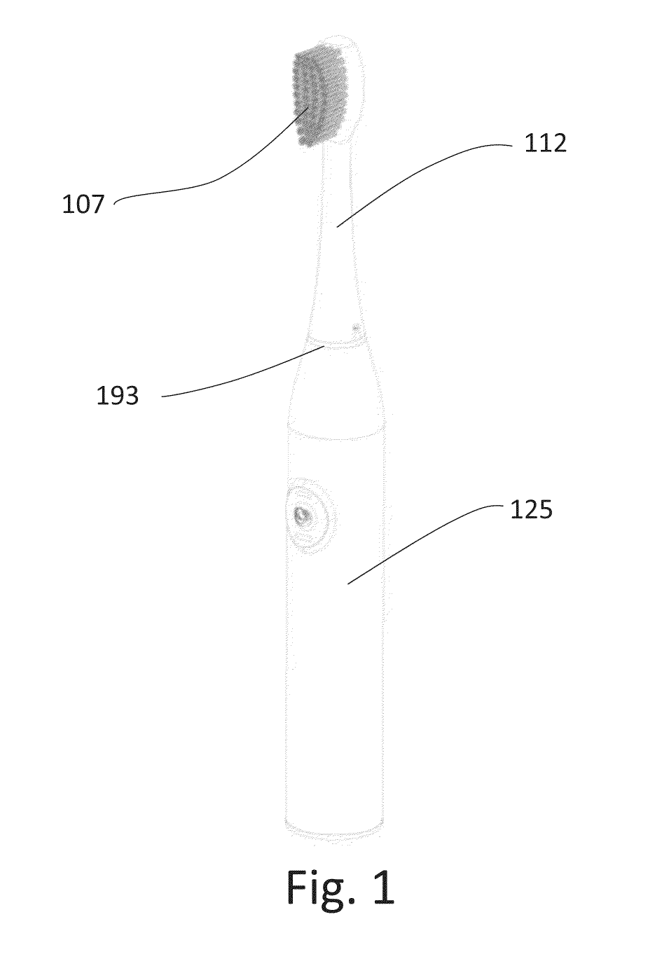

FIG. 2 is a flow diagram of a data transferring toothbrush system according to multiple embodiments and alternatives.

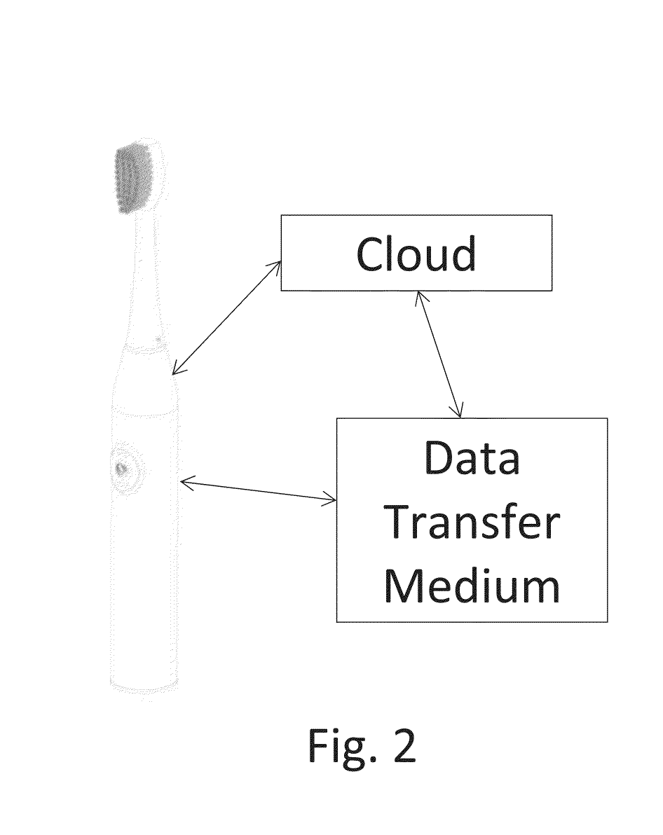

### DETAILED DESCRIPTION OF THE INVENTION

The data transferring power toothbrush is encompassed in a plurality of embodiments that shall be discussed in the present section.

A plurality of embodiments comprise a toothbrush. A toothbrush is an oral health care implement used for the cleaning of teeth and gingiva, more commonly referred to as gums. The toothbrush is operated in the oral cavity of a human being characterized as the first portion of the alimentary canal that receives food and saliva, and containing a mucous membrane epithelium lining referred to as the oral mucosa. The oral cavity is further characterized as having alveolar arches typically containing teeth, which are either natural, synthetic, or a combination thereof, and used primarily for the preparatory chewing of food for digestion.

A toothbrush comprises a brush head 112 consisting of a plurality of bristles 107 arranged into compact clusters, often referred to as tufts, mounted onto the brush head. Accordingly, the tufts are often mounted in an intentional pattern to facilitate cleaning of teeth and gums. A toothbrush further comprises a handle 125 that extends proximally from the brush head and is used for grasping and movement of the toothbrush. The bristles 107 of the toothbrush are commonly manufactured from either a natural material, synthetic material, or a combination thereof. One example of a natural bristle material is animal hair. An example of a typical synthetic bristle material is Nylon.

Inherently, a toothbrush has an associated motion when in use, which is characterized as either manually driven (i.e. manual toothbrush) or electromechanically driven (i.e. powered toothbrush). A manually driven motion is regarded as a motion generated by the user by his/her own power. Conversely, an electromechanically driven motion is characterized as a motion generated by electrical power which is converted to mechanical power used to create the specified electromechanically driven motion. In some embodiments, the electromechanically driven motion is a side-to-side oscillating motion also referred to as vibratory motion. Often, the vibratory motion is generated by an electric motor with an eccentric weight on the drive shaft of the electric motor. In other instances, the vibratory motion is generated by an electrically conductive coil around the outside of a magnetic mass, such that when an alternating current is applied to the coil, the magnetic mass oscillates causing vibration of the toothbrush. In other embodiments, the electromechanically driven motion is a rotation-oscillation motion wherein the head rotates either clockwise or counter-clockwise and then rotates in the opposite direction of the first rotation. Additionally, a portion of the brush head may move in a translational motion to provide additional cleaning.

In the case of a powered toothbrush, the user is required turn “on” the electromechanically driven motion via a user input. Optionally, the user input may be the actuation of a button or switch. Additionally, the user input may be the activation of a capacitive sensor recognizing that the user has touched a specified region of the toothbrush. Conversely, the powered toothbrush often requires the user to “off” the electromechanically driven motion. This is often achieved via the same user input that is used to turn “on” the electromechanically driven motion. Inherently, at least one period of time lapses between the electromechanically driven motion being turned “on” and turned “off.” This period of time can be recognized as the toothbrush usage time. Thus, the user can monitor his/her toothbrush usage time based on the turning “on” and “off” of the electromechanically driven motion.

In the case of a powered toothbrush utilizing vibratory motion, a desired step of the invention is to minimize the about of vibration transferred to the handle of the toothbrush where it is grasped by the user. The loss of vibratory motion to the handle decreases the effectiveness of the vibratory motion for cleaning at the brush head. In most cases, the vibratory motion driver, often an electric motor with an eccentric weight, is held at least partially by a motor housing that limits its movement within the handle of the toothbrush. Optionally, the motor housing is configured such that one end extends to the brush head and contacts at least a portion of the brush head. The other end is contained within the handle of the toothbrush. Additionally, a buffer 193 is provided between the main body of the motor housing on the end contained within the handle and the handle itself. The buffer 193 is often in the form of a more pliable material than the motor housing or handle material. Optionally, the buffer is an air gap provided between the motor housing and the handle.

The toothbrush further comprises a data processing unit having at least one collector, a storage medium, and at least one processor, wherein the collector, storage medium, and processor, respectively, collect, store, and process data. Accordingly, the data processing unit is chosen from the group microprocessor, microcontroller, field programmable gate array (FPGA), digital signal processing unit (DSP), application specific integrated circuit (ASIC), programmable logic, and combinations thereof.

Additionally, in some embodiments, the collector of the data processing unit is an electrically conductive wire, wherein the electrically conductive wire receives the electrical output of various sensors.

Moreover, the storage medium of the data processing unit is comprised of volatile memory and non-volatile memory, wherein volatile memory is used for short-term storage and processing, and non-volatile memory is used for long-term storage. Accordingly, volatile memory is chosen from the group random-access memory (RAM), dynamic random-access memory (DRAM), double data rate synchronous dynamic random-access memory (DDR SDRAM), static random-access memory (SRAM), thyristor random-access memory (T-RAM), zero-capacitor random-access memory (Z-RAM), and twin transistor random-access memory (TTRAM). Non-volatile memory is chosen from the group read-only memory (ROM), programmable read-only memory (PROM), erasable programmable read-only memory (EPROM), electrically erasable programmable read-only memory (EEPROM), flash memory, ferroelectric random-access memory (FeRAM), magnetoresistive random-access memory (MRAM), phase-change memory (PRAM), conductive-bridging random-access memory (CBRAM), silicon-oxide-nitride-oxide-silicon memory (SONOS), resistive random-access memory (RRAM), racetrack memory, nano-random-access memory (NRAM), and Millipede memory.

The processor of the data processing unit is chosen from the group microprocessor and micro controller.

Optionally, the toothbrush further comprises at least one data extractor, such that the data can be extracted to be used by another medium. The data is packaged as at least one signal and transmitted to another medium. The data extractor is chosen form the group universal serial bus (USB), serial port, wired Ethernet port, radio frequency, microwave communication, infrared short-range communication, near field communication, and Bluetooth®.

Optionally, the data processing unit stores the toothbrush usage time until it is transferred to an external medium via the data extractor. This allows the user to transfer data generated by the toothbrush to an external medium for viewing and manipulation outside of the toothbrush.

Optionally, the orientation sensor is at least one gyroscope, wherein the orientation sensor measures orientation based on the principle of conservation of angular momentum. Alternatively, the orientation sensor measures orientation based on the physical principle that a vibrating object tends to continue vibrating in the same plane as its support rotates, otherwise known as a vibrating structure gyroscope. In further options, the gyroscope is a microelectromechanical system. Accordingly, the microelectromechanical system that is a vibrating structure gyroscope utilizes a mechanism chosen from the group piezoelectric gyroscope, which uses a piezoelectric material to induce vibration; wine glass resonator, which uses a hemisphere that is driven to resonance; tuning fork gyroscope, which uses two tests masses that are driven to resonance; vibrating wheel gyroscope, which uses a wheel that is driven a fraction of a full turn about its axis; and any combination thereof.

Optionally, the orientation sensor is at least one accelerometer and at least one gyroscope, wherein the accelerometer and the gyroscope operate in conjunction to produce measurement of the full six degrees of freedom. The full six degrees of freedom are characterized as forward/backward, up/down, left/right, pitch, yaw, and roll.

Accordingly, in some embodiments, the data processing unit and the orientation sensor, both of the toothbrush, operate in conjunction to provide means for determining position of the brush head within the oral cavity. The orientation sensor detects the orientation of the toothbrush and transmits a signal to the data processing unit. The collector of the data processing unit receives the signal, and the storage medium stores the signal in the form of data. The processor of the data processing unit operates in conjunction with the storage medium to compare the stored orientation data to previously stored orientation data that correlates to certain positions within the oral cavity. Optionally, the previously stored orientation data that correlates to certain positions within the oral cavity is collected by placing the brush head of the toothbrush at various predetermined positions within the oral cavity, wherein the orientation sensor output is stored at each predetermined position, thus creating correlation data for comparison. Additionally, the toothbrush position data can be correlated to time data provided by RTCC based on motor actuation or capacitive touch sensor data to provide the user with brushing time measurements segmented by different positions within the oral cavity.

Additionally, the data corresponding to brushing time measurements segmented by different positions within the oral cavity can be transferred to an external medium via the data extractor.

In some embodiments, the data transferring powered toothbrush including variations described herein is comprised in a system that allows a user to view and monitor the measured data via a data transfer medium, such as a “smartphone”, and/or a network storage device, often known as the “cloud” and hereinafter referred to as the Cloud. Embodiments of the toothbrush comprised in this system include the data extractor described previously. Accordingly, the system allows the toothbrush to transfer data to the data transfer medium and/or the Cloud. Additionally, the data transfer medium may transfer said data to the Cloud for display and manipulation on further data transfer mediums connected to said Cloud. Alternatively, the Cloud may transfer said data to the data transfer medium.

In some embodiments, the data transfer medium comprises a receiver, a transmitter, a data processing unit, and a display. Accordingly, the data processing unit is chosen from the group microprocessor, microcontroller, field programmable gate array (FPGA), digital signal processing unit (DSP), application specific integrated circuit (ASIC), programmable logic, and combinations thereof. The data processing unit comprises a collector, storage medium, and a processor.

Moreover, the storage medium of the data processing unit is comprised of volatile memory and non-volatile memory, wherein volatile memory is used for short-term storage and processing, and non-volatile memory is used for long-term storage. Accordingly, in some embodiments, volatile memory is chosen from the group random-access memory (RAM), dynamic random-access memory (DRAM), double data rate synchronous dynamic random-access memory (DDR SDRAM), static random-access memory (SRAM), thyristor random-access memory (T-RAM), zero-capacitor random-access memory (Z-RAM), and twin transistor random-access memory (TTRAM). Optionally, in some embodiments, non-volatile memory is chosen from the group read-only memory (ROM), programmable read-only memory (PROM), erasable programmable read-only memory (EPROM), electrically erasable programmable read-only memory (EEPROM), flash memory, ferroelectric random-access memory (FeRAM), magnetoresistive random-access memory (MRAM), phase-change memory (PRAM), conductive-bridging random-access memory (CBRAM), silicon-oxide-nitride-oxide-silicon memory (SONOS), resistive random-access memory (RRAM), racetrack memory, nano-random-access memory (NRAM), and Millipede memory.

Further still, the processor of the data processing unit is chosen from the group microprocessor and microcontroller.

Additionally, the receiver of the data transfer medium is chosen from the group universal serial bus (USB), serial port, wired Ethernet port, radio frequency, microwave communication, infrared short-range communication, near field communication, and Bluetooth. Often, the receiver of the data transfer medium receives at least one signal from the data extractor of the toothbrush.

Optionally, the data transfer medium is chosen from the group personal computer, tablet computer, mobile phone (i.e. “smartphone”), television, dedicated system, charging station, network router, and web-enabled server.

Optionally, the transmitter of the data transfer medium is chosen from the group universal serial bus (USB), serial port, wired Ethernet port, radio frequency, microwave communication, infrared short-range communication, near field communication, and Bluetooth.

Additionally, the display of the data transfer medium converts signals into user-readable formats.

In some embodiments, the Cloud is connected to a network, wherein the network is chosen from the group Internet or intranet such that an intranet is a network managed and accessed by an internal organization and is not accessible to the outside world. The network is utilized by the Cloud for receiving and transmitting data. The mode for receiving and transmitting data through the network is chosen from the group universal serial bus (USB), serial port, wired Ethernet port, radio frequency, microwave communication, infrared short-range communication, near field communication, and Bluetooth.

Additionally, the Cloud processes data using at least one microprocessor, at least one microcontroller, or a combination thereof. The storage of data is comprised of volatile memory and non-volatile memory, wherein volatile memory is used for short-term storage and processing, and non-volatile memory is used for long-term storage. Accordingly, volatile memory is chosen from the group random-access memory (RAM), dynamic random-access memory (DRAM), double data rate synchronous dynamic random-access memory (DDR SDRAM), static random-access memory (SRAM), thyristor random-access memory (T-RAM), zero-capacitor random-access memory (Z-RAM), and twin transistor random-access memory (TTRAM). Optionally, non-volatile memory is chosen from the group read-only memory (ROM), programmable read-only memory (PROM), erasable programmable read-only memory (EPROM), electrically erasable programmable read-only memory (EEPROM), flash memory, ferroelectric random-access memory (FeRAM), magnetoresistive random-access memory (MRAM), phase-change memory (PRAM), conductive-bridging random-access memory (CBRAM), silicon-oxide-nitride-oxide-silicon memory (SONOS), resistive random-access memory (RRAM), racetrack memory, nano-random-access memory (NRAM), and Millipede memory.

The Cloud, optionally, is a network server primarily used for storing and processing data. Optionally, the Cloud is comprised of more than one network server such that the network servers operate in conjunction to increase the storing and processing capabilities of the Cloud. Alternatively, the Cloud is provided as a service such that it is physically located at a location separate from the user, and the service provided is the storing and processing of data.

In some embodiments, the system comprising the toothbrush facilitates the user's participation in social games related to the data collected by the toothbrush. Participation in said social games is accomplished passively through the collection of data by the sensors of the toothbrush over a period of time, rather than participation by real-time user input. Optionally, the social games consist of goals to be accomplished, competitive games between multiple users or between a singular user and a computer generated user, and challenges to complete specified milestones.

Participation in social games is accomplished through a plurality of different user groups. The first user group for participation is a closed loop user group, which is accomplished on a specific data transfer medium and participation is limited to the users of said specific data transfer medium. The second user group for participation is a networked user group, which is accomplished over a network that connects a plurality of data transfer mediums. Networked user groups are further defined as including users belonging to a certain group defined through social media or other means. The third user group for participation is a global user group, which is a user group that anyone can join and participate in. The global user group, in some embodiments, may be sponsored or promoted by a particular entity as a form of advertisement or incentive to the users of the global user group.

Participation in social games may be incentivized with an offered reward to encourage participation of members of a user group. Rewards may include coupons, discounts on goods or services, virtual currency, insurance discounts, and customized incentives. Rewards have the advantage of being given based off of passive data collected by sensors, thus rewarding users for health compliance and health statistics.

In some embodiments, the system and toothbrush provide for the user's active participation in real-time games using the toothbrush as a controller. Optionally, the game interface is comprised in the data transfer medium, such that it displays the interactions and provides the processing and storage means for the game. Additionally, games can encourage a user to complete proper brushing within the entire oral cavity and direct the user to move to underserved areas of the oral cavity through game interaction.

It will be understood that the embodiments described herein are not limited in their application to details of the teachings and descriptions set forth, or as illustrated in the accompanying figures. Rather, it will be understood that a data transferring powered toothbrush, as taught and described according to multiple embodiments disclosed herein, is capable of other embodiments and of being practiced or carried out in various ways.

Also, it is to be understood that the phraseology and terminology used herein is for the purpose of description and should not be regarded as limiting. The use herein of “including,” “comprising,” “i.e.,” “containing,” or “having,” and variations of those words is meant to encompass the items listed thereafter, and equivalents of those, as well as additional items.

Accordingly, the descriptions herein are not intended to be exhaustive, nor are they meant to limit the understanding of the embodiments to the precise forms disclosed. It will be understood by those having ordinary skill in the art that modifications and variations of these embodiments are reasonably possible in light of the above teachings and descriptions.

What is claimed is:

1. A powered toothbrush, comprising:
a handle having a distal end and a proximal end;
a brush head having a plurality of bristles and that is arranged to be detachably connected the distal end of the handle;
a motor housing having an electromechanical drive that is configured to provide mechanical movement of the brush head and an outer shell that is arranged to retain the electromechanical drive;
a data processing unit having at least one collector that is configured to collect data, a storage medium that is configured to store data, and at least one processor that is configured to process data;
a transceiver that is configured to transmit and receive data; and
an orientation sensor that is configured to measure orientation of the powered toothbrush.

2. The powered toothbrush of claim 1, wherein the transceiver is chosen from the group consisting of universal serial bus (USB), serial port, wired Ethernet port, radio frequency, microwave communication, infrared short-range communication, near field communication, Bluetooth, Wi-Fi, and any combination thereof.

3. The powered toothbrush of claim 1, wherein the orientation sensor is chosen from the group at least one gyroscope, at least one accelerometer, and any combination thereof.

4. The powered toothbrush of claim 1, wherein the data process unit is configured to measure the toothbrush usage time by measuring the time period between the electromechanical drive activation and the electromechanical drive deactivation.

5. The powered toothbrush of claim 4, wherein the orientation sensor and the data processing unit are configured to operate in conjunction to determine the position of the brush head within the oral cavity.

6. The powered toothbrush of claim 5, wherein the data processing unit is configured to correlate the position of the brush head within the oral cavity and the toothbrush usage time.

7. The powered toothbrush of claim 6, wherein the data processing unit is configured to determine the amount of time the brush head is located in various positions within the oral cavity.

8. The powered toothbrush of claim 1, further comprising a buffer that arranged to be located between the motor housing and the handle.

9. The powered toothbrush of claim 8, wherein the buffer is made from a more pliable material than that of both the motor housing and the handle.

10. The powered toothbrush of claim 8, wherein the buffer is configured to reduce the amount of vibration transferred from the motor housing to the handle.

11. The powered toothbrush of claim 10, wherein the buffer is configured to amplify the amount of vibration transferred to the brush head.

12. A powered toothbrush system, comprising:
a powered toothbrush having a handle having a distal end and a proximal end, a brush head having a plurality of bristles and that is arranged to be detachably connected to the distal end of the handle, a motor housing having an electromechanical drive that is configured to provide mechanical movement of the brush head and an outer shell that is arranged to retain the electromechanical drive, a data processing unit that is configured to store and process data, a transceiver that is configured to receive and transmit data, and an orientation sensor that is configured to measure the orientation of the powered toothbrush; and
a cloud computing network having at least one data processing unit that is configured to store and process data and a transceiver that is configured to receive and transmit data.

13. The powered toothbrush system of claim 12, wherein the transceiver of the powered toothbrush is chosen from the group consisting of universal serial bus (USB), serial port, wired Ethernet port, radio frequency, microwave communication, infrared short-range communication, near field communication, Bluetooth, Wi-Fi, and any combination thereof.

14. A powered toothbrush system, comprising:
a powered toothbrush having a handle having a distal end and a proximal end, a brush head having a plurality of bristles and that is arranged to be detachably connected to the distal end of the handle, a motor housing having an electromechanical drive that is configured to provide mechanical movement of the brush head and an outer shell that is arranged to retain the electromechanical drive, a data processing unit that is configured to store and process data, a transceiver that is configured to receive and transmit data, and an orientation sensor that is configured to measure the orientation of the powered toothbrush;
a cloud computing network having at least one data processing unit that is configured to store and process data and a transceiver that is configured to receive and transmit data; and
a data transfer medium having a transceiver that is configured to receive and transmit data, a data processing unit that is configured to store and process data, and a display medium that is configured to display data.

15. The powered toothbrush system of claim 14, wherein the transceiver of the powered toothbrush is chosen from the group consisting of universal serial bus (USB), serial port, wired Ethernet port, radio frequency, microwave communication, infrared short-range communication, near field communication, Bluetooth, Wi-Fi, and any combination thereof.

16. The powered toothbrush system of claim 14, wherein the transceiver of the data transfer medium is chosen from the group consisting of universal serial bus (USB), serial port, wired Ethernet port, radio frequency, microwave communication, infrared short-range communication, near field communication, Bluetooth, Wi-Fi, and any combination thereof.

17. The powered toothbrush system of claim 14, wherein the data transfer medium further comprises a user interface that is configured to facilitate participation in social games such that participation is accomplished passively through data collection of the powered toothbrush over a period of time.

18. The powered toothbrush system of claim 14, wherein the data transfer medium further comprises a user interface that is configured to facilitate active participation in games, wherein the powered toothbrush is a game controller.

19. The powered toothbrush system of claim 14, wherein the powered toothbrush further comprising a buffer that arranged to be located between the motor housing and the handle.

20. The powered toothbrush system of claim 19, wherein the buffer of the powered toothbrush is made from a more pliable material than that of both the motor housing and the handle, both of the powered toothbrush.
